(19) United States
(12) Patent Application Publication
(10) Pub. No.: US 2025/0346331 A1
(43) Pub. Date: Nov. 13, 2025

(54) ANTICORROSIVE CONSTRUCTION MACHINE FOR COFFERDAM OF A SHIP

(71) Applicant: Zhejiang International Maritime College, Zhoushan (CN)

(72) Inventors: Zailiang Liu, Zhoushan (CN); Hailing Zhang, Zhoushan (CN)

(21) Appl. No.: 18/947,527

(22) Filed: Nov. 14, 2024

(30) Foreign Application Priority Data
May 7, 2024 (CN) 202410553638.1

(51) Int. Cl. B63B 81/00

(52) U.S. Cl. CPC B63B 81/00

(57) ABSTRACT

An anticorrosive construction machine for cofferdam of a ship comprises a support, a grinding roller, a support device, a lifting device, a driving device, a heat exchange device, a spraying device, a machine case, a collecting hood, a fan, a first conveying tube and an exhaust hood; the grinding roller is rotatably arranged on inner wall of the support, the machine case is arranged on the support device, the support is arranged on a side of the machine case in a vertically moving mode via lifting device, the collecting hood is arranged on inner wall of support, the fan is arranged on outer wall of support, the driving device is arranged on the support for providing power for grinding roller and fan, input end of the first conveying tube is connected with the collecting hood, and output end of the first conveying tube is connected with the fan.

### 1. TECHNICAL FIELD

The invention relates to the technical field of anticorrosive construction machine, in particular to an anticorrosive construction machine for cofferdam of a ship.

### 2. BACKGROUND ART

The anticorrosive construction machine for cofferdam of a ship is a kind of machine specially used for the internal anticorrosion treatment of the cofferdam of a ship, with the continuous development of the ship industry, the anticorrosion requirements of the ship's internal space is also more and more high, especially in the marine environment, the cofferdam of a ship is often subject to the erosion of the salt spray, moisture and other harsh environments, which leads to rust and corrosion of the internal metal structure of the cofferdam, and seriously affects the safety and service life of the ship, therefore, it is necessary to carry out anticorrosion treatment periodically.

At present, in the anticorrosion construction, such as the patent with the prior art authorization number CN215783030U, the utility model discloses a polymer waterproof anticorrosion coating construction system, which belongs to the technical field of the coating processing device, and it includes an operation table, a mixer is provided on an upper surface of the operation table, a lower surface of the mixer is fixedly connected with the upper surface of the operation table, a mixing box is provided in the mixer, and a slot is opened on the upper surface of the operation table. For the high polymer waterproof anticorrosion coating construction system, the first motor drives the driving roller and turntable to rotate via the installation of push plate, the fixed rod pushes the clamping block to drive the push plate to sway left and right through the limit ring, and the second connecting rod swings up and down through the pin to drive the first connecting rod and the push plate to sway up and down.

But in the use of the equipment, it's found that the equipment is not easy to realize the automatic descaling and spraying anticorrosive material processing of the cofferdam, increasing the labor intensity of manual operation, reducing the construction efficiency, and it's not convenient for the equipment to use heat during the work of anticorrosive materials for heating, prone to cause low fluidity of the viscous material in low temperature environment and long drying time, affecting the progress of the construction.

### 3. SUMMARY OF THE INVENTION

In order to solve the technical problem, the invention provides an anticorrosive construction machine for cofferdam of a ship, which utilizes the heat in of collecting debris and air to heat the anticorrosive material to increase the temperature, liquidity and drying speed thereof, the hot air will dry the anticorrosive materials after spraying, improve the air waste heat utilization and drying speed of the anticorrosive material, and improving drying speed of the anticorrosive materials.

An anticorrosive construction machine for cofferdam of a ship comprises a support, a grinding roller, a support device, a lifting device, a driving device, a heat exchange device, a spraying device, a machine case, a collecting hood, a fan, a first conveying tube and an exhaust hood, wherein the grinding roller is rotatably arranged on an inner wall of the support, the machine case is arranged on the support device, the support is arranged on a side of the machine case in a vertically moving mode via the lifting device, the collecting hood is arranged on the inner wall of the support, the fan is arranged on an outer wall of the support, the driving device is arranged on the support and used for providing power for the grinding roller and the fan, an input end of the first conveying tube is connected with the collecting hood, and an output end of the first conveying tube is connected with the fan; an output end of the fan is connected to the heat exchange device, which is used to heat the anticorrosive material, the exhaust hood is installed on an outer wall of the machine case and is connected to the heat exchange device; the spraying device is installed on the machine case, which is used to spray the anticorrosive material; the position of the machine case is moved by the support device, so that the machine case drives the grinding roller to contact with the bulkhead where anticorrosion construction is needed. After that, the grinding roller and fan are powered by the driving device to make the grinding roller rotate and then grind and descale the bulkhead, and at the same time, the fan suctions the air in the collecting hood to make the collecting hood collect the ground debris, the air is heated up by the grinding roller due to the friction of the grinding roller in the grinding process; the collected debris and air are transported to the heat exchange device through the fan, and heat exchange device utilizes the heat of collecting debris and air to heat the anticorrosive material to increase the temperature, liquidity and drying speed thereof, then the heat exchange device will filter the collected debris, and the separated air will be heated again and transported to the exhaust hood, so that the exhaust hood will dry the anticorrosive materials after spraying, improve the waste air utilization, reduce the energy consumption of secondary heating of the air, improve the drying speed of the anticorrosive materials, and improve the efficiency of the construction.

Preferably, the heat exchange device includes a heating device, two conveying cylinders, a plurality of heat exchange tubes, a plurality of guide plates, a housing, a second conveying tube, a filter box, a filter screen, a third conveying tube and a car body; two conveying cylinders are respectively installed on left and right parts of the machine case, left and right ends of a plurality of heat exchange tubes are respectively connected to two conveying cylinders, a plurality of guide plates are installed on outer wall of a plurality of heat exchange tubes in a staggered manner, two ends of the housing are connected to two conveying cylinders, and the housing is installed out of the heat exchange tubes, and the spraying device is connected to an interior of the housing, right conveying cylinder is connected to an output end of the fan, left conveying cylinder is connected to the second conveying tube, and an output end of the second conveying tube is connected to the filter box, which is installed at a top of the car body, and the support device is installed at a top of the filter box, the filter screen is installed in an inner wall of the filter box and there is a heating device in the filter box for heating the air for the second time; an input end of the third conveying tube is connected with the heating device, and an output end of the third conveying tube is connected with the exhaust hood; the fan conveys the debris collected by the collecting hood to the right conveying cylinder, and then the debris and hot air flow through a plurality of heat exchange tubes into the left conveying cylinder, and the air flow process will heat a plurality of heat exchange tubes, and then the anticorrosive material will be conveyed inside the housing to make the anticorrosive materials heated up by a plurality of heat exchange tubes, and the anticorrosive materials are guided through a plurality of guide plates to improve the heat exchanging effect of a plurality of heat exchange tubes on the anticorrosive materials. After that, the air and debris are conveyed inside the filter box through the second conveying tube, the debris are filtered through the filter screen and the filtered air is conveyed to the heating device, which heats up the air for a second time and then conveys it to the exhaust hood through the third conveying tube to make the exhaust hood dry the anticorrosive materials after spraying, improves the heat recovery effect of the construction machine, and improves the working efficiency.

Preferably, the spraying device comprises a fourth conveying tube, a plurality of spray nozzles, a storage tank, a pump, a fifth conveying tube and a sixth conveying tube; the fourth conveying tube is mounted on the outer wall of the machine case, the fourth conveying tube is connected with the interior of the housing, a plurality of spray nozzles are connected to an outer wall of the fourth conveying tube, and the storage tank is mounted on the top of the car body; the pump is mounted on an outer wall of the filter box, an input end of the pump is connected to the storage tank, an output end of the pump is connected to the fifth conveying tube, an output end of the fifth conveying tube is connected to the housing, an input end of the sixth conveying tube is connected to interior of the filter box, and an output end of the sixth conveying tube is connected to the storage tank; the anticorrosive materials are extracted from the storage tank by opening the pump, and the extracted anticorrosive materials are transported to interior of the housing through the fourth conveying tube, so that the anticorrosive materials are heated up in the interior of the housing by using the heat of air, and after that the anticorrosive materials are transported to a plurality of spray nozzles through the fourth conveying tube, and then the anti-corrosive materials are sprayed on the wall of the bulkhead after grinding and descaling is finished by a plurality of spray nozzles. When the anticorrosive materials in the storage tank are reduced, the hot air in the filter box is transported to the storage tank through the sixth conveying tube, so as to improve the heat preservation of the anticorrosive materials in the storage tank, and to improve the convenience of the use of the construction machine.

Preferably, the support device comprises a power device, a first rotary table, a guide arm, a second rotary table, a cross arm, a connecting arm, a third rotary table and a plurality of first electric cylinders; the first rotary table is mounted on the top of the filter box, the guide arm is mounted on a rotary end of the first rotary table, the guide arm is equipped with a power device, which is used to drive the second rotary table to go up and down, the cross arm is mounted on a rotary end of the second rotary table, a top of the connecting arm is connected to an end of the cross arm, the third rotary table is mounted on a bottom end of the connecting arm, and a rotary end of the third rotary table is connected to top end of the machine case; a plurality of the first electric cylinders are all rotatably mounted on an outer wall of the cross arm, and mobile ends of a plurality of the first electric cylinders are all rotatably connected to an outer wall of the connecting arm; the first rotary table to drive the guide arm to rotate make the guide arm drive the machine case to move to a different position, and by controlling the expansion and contraction length of the mobile ends of a plurality of the first electric cylinders, the first electric cylinders drive the connecting arm to adjust to vertical or horizontal angle, so as to improve the convenience of the construction machine to work on the bottom and side bulkheads, and the second rotary table drives the cross arm to rotate, so that the cross arm drives the machine case upward to improve the convenience of the construction machine to work on top of the bulkheads, and to improve the flexibility of adjusting to different construction positions.

Preferably, the driving device comprises a first motor, a first pulley, a second pulley and a belt; the first motor is mounted on the inner wall of the support, an output end of the first motor is connected to the fan, and another output end of the first motor is connected to the first pulley; the second pulley is mounted on an end of the grinding roller, and the belt is sleeved on an outer wall of the first pulley and the second pulley; by turning on the first motor, the first motor drives the fan, and at the same time the first motor drives the first pulley to rotate, and the first pulley drives the second pulley to rotate through the belt, so that the second pulley drives the grinding roller to rotate, so as to improve convenience of using the construction machine.

Preferably, the power device includes a sliding block, a leading screw and a second motor; the sliding block is mounted in an inner wall of the guide arm in sliding up and down mode, the second rotary table is mounted on an outer wall of the sliding block, the leading screw is rotatably mounted on the inner wall of the guide arm, the sliding block is threadedly mounted on the leading screw, the second motor is mounted on a top end of the guide arm, and an output end of the second motor is connected with the leading screw; the leading screw is driven by the second motor to rotate and to drive the sliding block to move up and down, so that the sliding block will drive the machine case to move up and down to adjust and improve the flexibility of using the construction machine.

Preferably, the lifting device includes a support table, a second electric cylinder and a plurality of guide columns; the support table is mounted on an outer wall of the machine case, the second electric cylinder is mounted on an outer wall of the support table, mobile end of the second electric cylinder is connected to a top end of the support, and a plurality of guide columns are all slidably mounted on the support table, and bottom ends of a plurality of guide columns are all connected to the top end of the support; the support is driven by the second electric cylinder to go up and down, so the support is driven to adjust the of the grinding roller, and up and down stability of the support is improved by installing a plurality of guide columns.

Preferably, the heating device includes a mesh box and electric heating tubes, the mesh box is connected to interior of the filter box, a top end of the mesh box is connected to an input end of the third conveying tube, and the electric heating tube is installed in an interior of the mesh box; the filtered air in the filter box flows through interior of the mesh box and enters into the third conveying tube, and the air is heated up by the electric heating tube, so as to make the hot air dry the anticorrosive materials after spraying.

Preferably, it also includes a plurality of bases and a plurality of ball transfers; a plurality of bases is installed on a bottom of the machine case, and a plurality of ball transfers are rotatably mounted on a plurality of bases; the stability of the machine case for mobile use is improved through support of a plurality of ball transfers on the bottom of the machine case.

Preferably, there is also a closed door, and the closed door is connected to the outer wall of the filter box; by opening the closed door, it improves the convenience of cleaning and discharging the ground debris in the filter box.

Compared with the prior art, the invention has the following advantages: the position of the machine case is moved by the support device, so that the machine case drives the grinding roller to contact with the bulkhead where anticorrosion construction is needed. After that, the grinding roller and fan are powered by the driving device to make the grinding roller rotate and then grind and descale the bulkhead, and at the same time, the fan suctions the air in the collecting hood to make the collecting hood collect the ground debris, the air is heated up by the grinding roller due to the friction of the grinding roller in the grinding process; the collected debris and air are transported to the heat exchange device through the fan, and heat exchange device utilizes the heat of collecting debris and air to heat the anticorrosive material to increase the temperature, liquidity and drying speed thereof, then the heat exchange device will filter the collected debris, and the separated air will be heated again and transported to the exhaust hood, so that the exhaust hood will dry the anticorrosive materials after spraying, improve the waste air utilization, reduce the energy consumption of secondary heating of the air, improve the drying speed of the anticorrosive materials, and improve the efficiency of the construction.

### 4. BRIEF DESCRIPTION OF ACCOMPANY DRAWINGS

FIG. 1 is an axonometric diagram of the invention;

FIG. 2 is an axonometric diagram of partial structure illustrating the support being connected to the collecting hood, etc;

FIG. 3 is an axonometric diagram of partial structure illustrating the machine case being connected to the conveying cylinder, etc;

FIG. 4 is an axonometric diagram of partial structure illustrating the machine case being connected to the bases, etc;

FIG. 5 is an axonometric diagram of partial structure illustrating the conveying cylinder being connected to the heat exchange tubes, etc;

FIG. 6 is an axonometric diagram of partial structure illustrating the storage tank being connected to the fifth conveying tube, etc;

FIG. 7 is an axonometric diagram of partial structure illustrating the support table being connected to the second electric cylinder, etc;

FIG. 8 is an axonometric diagram of partial structure illustrating the filter box being connected to the filter screen, etc;

FIG. 9 is an axonometric diagram illustrating the second rotary table being connected to the cross arm, etc;

FIG. 10 is an axonometric diagram illustrating the car body being connected to the filter box, etc;

FIG. 11 is an axonometric diagram of partial structure illustrating the first rotary table being connected to the guide arm, etc;

FIG. 12 is an axonometric diagram of partial structure illustrating the support table being connected to the second electric cylinder, etc;

FIG. 13 is an axonometric diagram of partial structure illustrating the leading screw being connected to the second electric cylinder, etc;

FIG. 14 is an axonometric diagram of partial structure illustrating the support being connected to the second electric cylinder, etc;

As shown in the accompanying drawings: 101 machine case, 102 support, 103 grinding roller, 104 collecting hood, 105 fan, 106 first conveying tube, 107 exhaust hood, 201 conveying cylinder, 202 heat exchange tube, 203 guide plate, 204 housing, 205 second conveying tube, 206 filter box, 207 filter screen, 208 third conveying tube, 209 car body, 301 fourth conveying tube, 302 spray nozzles, 303 storage tank, 304 pump, 305 fourth conveying tube, 306 fifth conveying tube, 401 first rotary table, 402 guide arm, 403 second rotary table, 404 cross arm, 405 connecting arm, 406 third rotary table, 407 first electric cylinder, 501 first motor, 502 first pulley, 503 second pulley, 504 belt, 601 sliding block, 602 leading screw, 603 second motor, 701 support table, 702 second electric cylinder, 703 guide column, 801 mesh box, 802 electric heating tube, 901 base, 902 ball transfer, 1001 closed door.

### 5. SPECIFIC EMBODIMENT OF THE INVENTION

In order to make the objects, technical solutions and advantages of the embodiments of the present invention clearer, the technical solutions in the embodiments of the invention will be clearly and completely described below with reference to the drawings in the embodiments of the invention. The invention can be realized in many different forms and is not limited to the embodiments described herein. Rather, these embodiments are provided for the purpose of making the disclosure of the invention more thorough and comprehensive.

### Embodiment

an anticorrosive construction machine for cofferdam of a ship, which utilizes the heat in of collecting debris and air to heat the anticorrosive material to increase the temperature, liquidity and drying speed thereof, the hot air will dry the anticorrosive materials after spraying, improve the air waste heat utilization and drying speed of the anticorrosive material, and improving drying speed of the anticorrosive materials.

An anticorrosive construction machine for cofferdam of a ship comprises a support 102, a grinding roller 103, a support device, a lifting device, a driving device, a heat exchange device, a spraying device, a machine case 101, a collecting hood 104, a fan 105, a first conveying tube 106 and an exhaust hood 107, wherein the grinding roller 103 is rotatably arranged on an inner wall of the support 102, the machine case 101 is arranged on the support device, the support 102 is arranged on a side of the machine case 101 in a vertically moving mode via the lifting device, the collecting hood 104 is arranged on the inner wall of the support 102, the fan 105 is arranged on an outer wall of the support 102, the driving device is arranged on the support 102 and used for providing power for the grinding roller 103 and the fan 105, an input end of the first conveying tube 106 is connected with the collecting hood 104, and an output end of the first conveying tube 106 is connected with the fan 105; an output end of the fan 105 is connected to the heat exchange device, which is used to heat the anticorrosive material, the exhaust hood 107 is installed on an outer wall of the machine case 101 and is connected to the heat exchange device; the spraying device is installed on the machine case 101, which is used to spray the anticorrosive material;
the heat exchange device includes a heating device, two conveying cylinders 201, a plurality of heat exchange tubes 202, a plurality of guide plates 203, a housing 204, a second conveying tube 205, a filter box 206, a filter screen 207, a third conveying tube 208 and a car body 209; two conveying cylinders 201 are respectively installed on left and right parts of the machine case 101, left and right ends of a plurality of heat exchange tubes 202 are respectively connected to two conveying cylinders 201, a plurality of guide plates 203 are installed on outer wall of a plurality of heat exchange tubes 202 in a staggered manner, two ends of the housing 204 are connected to two conveying cylinders 201, and the housing 204 is installed out of the heat exchange tubes 202, and the spraying device is connected to an interior of the housing 204, right conveying cylinder 201 is connected to an output end of the fan 105, left conveying cylinder 201 is connected to the second conveying tube 205, and an output end of the second conveying tube 205 is connected to the filter box 206, which is installed at a top of the car body 209, and the support device is installed at a top of the filter box 206, the filter screen 207 is installed in an inner wall of the filter box 206 and there is a heating device in the filter box 206 for heating the air for the second time; an input end of the third conveying tube 208 is connected with the heating device, and an output end of the third conveying tube 208 is connected with the exhaust hood 107;

In the embodiment, the position of the machine case 101 is moved by the support device, so that the machine case 101 drives the grinding roller 103 to contact with the bulkhead where anticorrosion construction is needed. After that, the grinding roller 103 and fan 105 are powered by the driving device to make the grinding roller 103 rotate and then grind and descale the bulkhead, and at the same time, the fan 105 suctions the air in the collecting hood 104 to make the collecting hood 104 collect the ground debris, the air is heated up by the grinding roller 103 due to the friction of the grinding roller 103 in the grinding process; the collected debris and air are transported to the heat exchange device through the fan 105, and heat exchange device utilizes the heat of collecting debris and air to heat the anticorrosive material to increase the temperature, liquidity and drying speed thereof, then the heat exchange device will filter the collected debris, and the separated air will be heated again and transported to the exhaust hood 107, so that the exhaust hood 107 will dry the anticorrosive materials after spraying, improve the waste air utilization, reduce the energy consumption of secondary heating of the air, improve the drying speed of the anticorrosive materials, and improve the efficiency of the construction.

### Embodiment 2

On the basis of embodiment 1, the invention provides an anticorrosive construction machine for cofferdam of a ship, wherein the spraying device comprises a fourth conveying tube 301, a plurality of spray nozzles 302, a storage tank 303, a pump 304, a fifth conveying tube 305 and a sixth conveying tube 306; the fourth conveying tube 301 is mounted on the outer wall of the machine case 101, the fourth conveying tube 301 is connected with the interior of the housing 204, a plurality of spray nozzles 302 are connected to an outer wall of the fourth conveying tube 301, and the storage tank 303 is mounted on the top of the car body 209; the pump 304 is mounted on an outer wall of the filter box 206, an input end of the pump 304 is connected to the storage tank 303, an output end of the pump 304 is connected to the fifth conveying tube 305, an output end of the fifth conveying tube 305 is connected to the housing 204, an input end of the sixth conveying tube 306 is connected to interior of the filter box 206, and an output end of the sixth conveying tube 306 is connected to the storage tank 303;
the support device comprises a power device, a first rotary table 401, a guide arm 402, a second rotary table 403, a cross arm 404, a connecting arm 405, a third rotary table 406 and a plurality of first electric cylinders 407; the first rotary table 401 is mounted on the top of the filter box 206, the guide arm 402 is mounted on a rotary end of the first rotary table 401, the guide arm 402 is equipped with a power device, which is used to drive the second rotary table 403 to go up and down, the cross arm 404 is mounted on a rotary end of the second rotary table 403, a top of the connecting arm 405 is connected to an end of the cross arm 404, the third rotary table 406 is mounted on a bottom end of the connecting arm 405, and a rotary end of the third rotary table 406 is connected to top end of the machine case 101; a plurality of the first electric cylinders 407 are all rotatably mounted on an outer wall of the cross arm 404, and mobile ends of a plurality of the first electric cylinders 407 are all rotatably connected to an outer wall of the connecting arm 405;
the driving device comprises a first motor 501, a first pulley 502, a second pulley 503 and a belt 504; the first motor 501 is mounted on the inner wall of the support 102, an output end of the first motor 501 is connected to the fan 105, and another output end of the first motor 501 is connected to the first pulley 502; the second pulley 503 is mounted on an end of the grinding roller 103, and the belt 504 is sleeved on an outer wall of the first pulley 502 and the second pulley 503;
the power device includes a sliding block 601, a leading screw 602 and a second motor 603; the sliding block 601 is mounted in an inner wall of the guide arm 402 in sliding up and down mode, the second rotary table 403 is mounted on an outer wall of the sliding block 601, the leading screw 602 is rotatably mounted on the inner wall of the guide arm 402, the sliding block 601 is threadedly mounted on the leading screw 602, the second motor 603 is mounted on a top end of the guide arm 402, and an output end of the second motor 603 is connected with the leading screw 602;
the lifting device includes a support table 701, a second electric cylinder 702 and a plurality of guide columns 703; the support table 701 is mounted on an outer wall of the machine case 101, the second electric cylinder 702 is mounted on an outer wall of the support table 701, mobile end of the second electric cylinder 702 is connected to a top end of the support 102, and a plurality of guide columns 703 are all slidably mounted on the support table 701, and bottom ends of a plurality of guide columns 703 are all connected to the top end of the support 102;
the heating device includes a mesh box 801 and electric heating tubes 802, the mesh box 801 is connected to interior of the filter box 206, a top end of the mesh box 801 is connected to an input end of the third conveying tube 208, and the electric heating tube 802 is installed in an interior of the mesh box 801;
it also includes a plurality of bases 901 and a plurality of ball transfers 902; a plurality of bases 901 are installed on a bottom of the machine case 101, and a plurality of ball transfers 902 are rotatably mounted on a plurality of bases 901;
there is also a closed door 1001, and the closed door 1001 is connected to the outer wall of the filter box 206;
in the embodiment, the fan 105 conveys the debris collected by the collecting hood 104 to the right conveying cylinder 201, and then the debris and hot air flow through a plurality of heat exchange tubes 202 into the left conveying cylinder 201, and the air flow process will heat a plurality of heat exchange tubes 202, and then the anticorrosive material will be conveyed inside the housing 204 to make the anticorrosive materials heated up by a plurality of heat exchange tubes 202, and the anticorrosive materials are guided through a plurality of guide plates 203 to improve the heat exchanging effect of a plurality of heat exchange tubes 202 on the anticorrosive materials. After that, the air and debris are conveyed inside the filter box 206 through the second conveying tube 205, the debris are filtered through the filter screen 207 and the filtered air is conveyed to the heating device, which heats up the air for a second time and then conveys it to the exhaust hood 107 through the third conveying tube 208 to make the exhaust hood 107 dry the anticorrosive materials after spraying, improves the heat recovery effect of the construction machine, and improves the working efficiency; the anticorrosive materials are extracted from the storage tank 303 by opening the pump 304, and the extracted anticorrosive materials are transported to interior of the housing 204 through the fourth conveying tube 301, so that the anticorrosive materials are heated up in the interior of the housing 204 by using the heat of air, and after that the anticorrosive materials are transported to a plurality of spray nozzles 302 through the fourth conveying tube 301, and then the anti-corrosive materials are sprayed on the wall of the bulkhead after grinding and descaling is finished by a plurality of spray nozzles 302. When the anticorrosive materials in the storage tank 303 are reduced, the hot air in the filter box 206 is transported to the storage tank 303 through the sixth conveying tube 306, so as to improve the heat preservation of the anticorrosive materials in the storage tank 303, and to improve the convenience of the use of the construction machine.

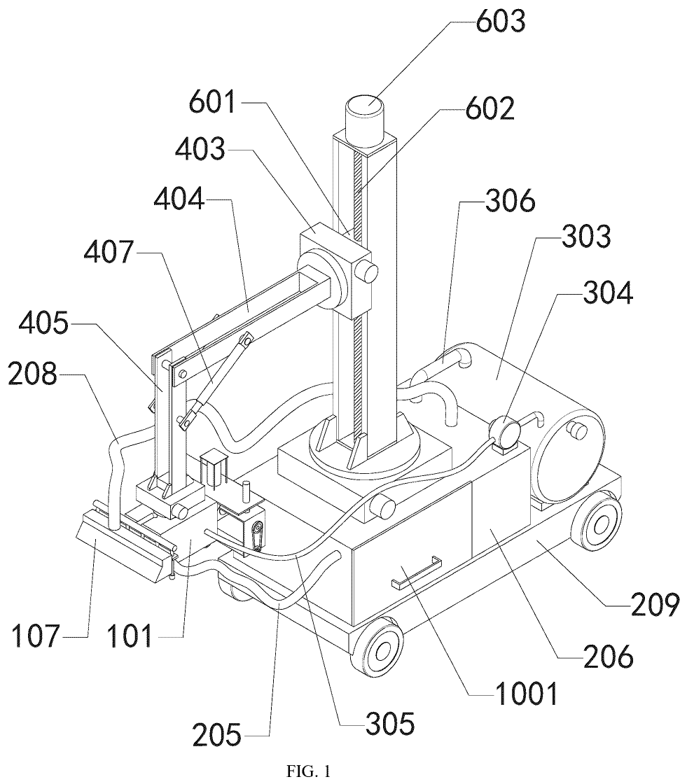

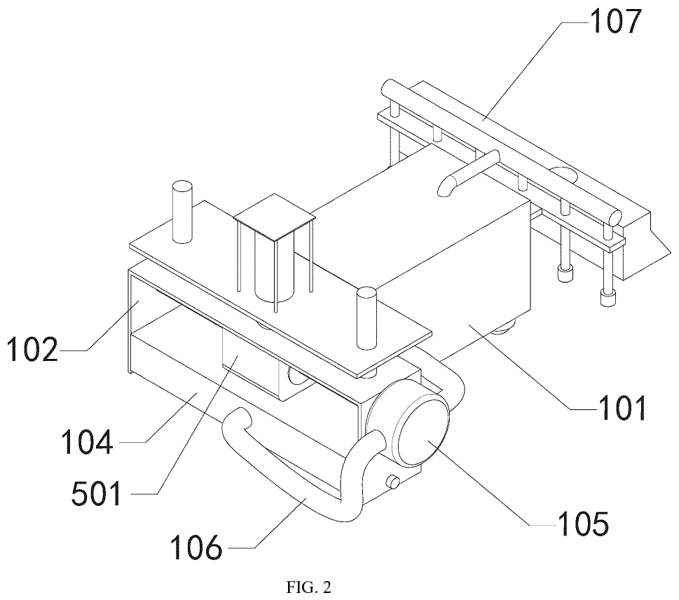

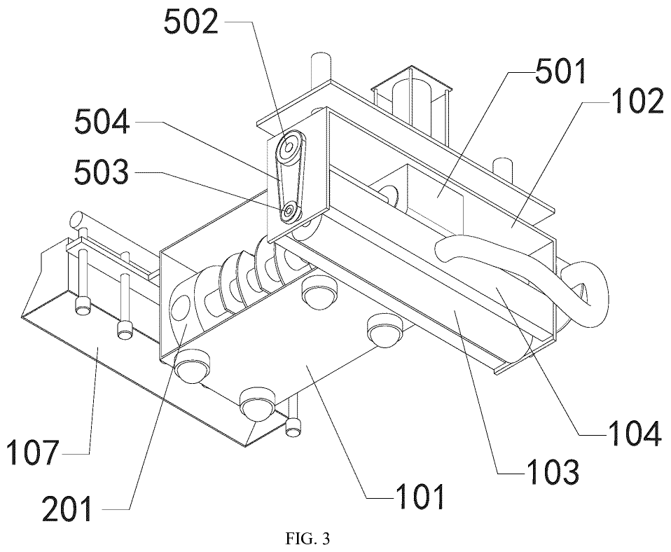

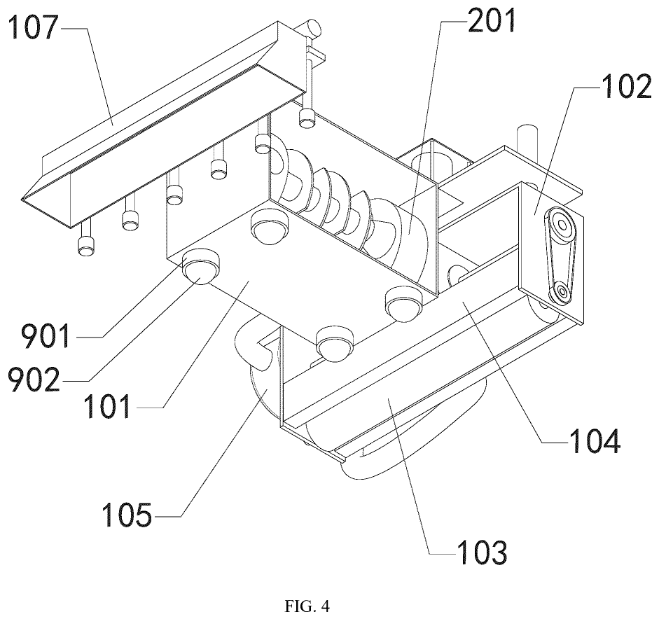

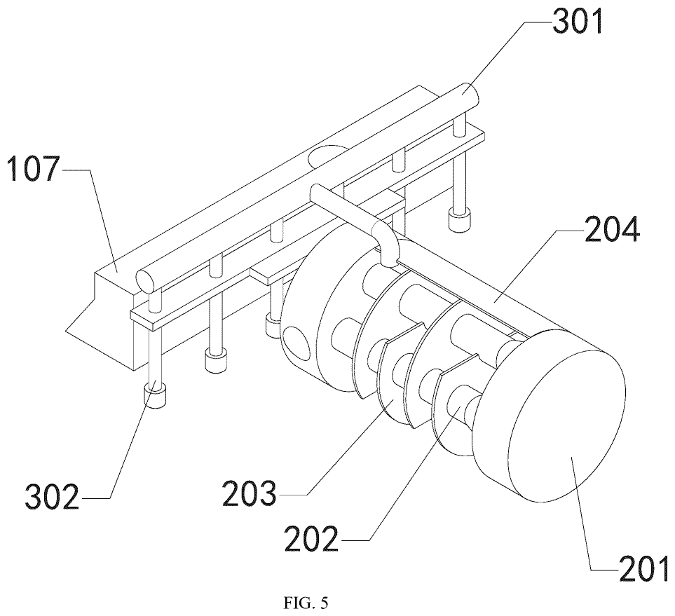

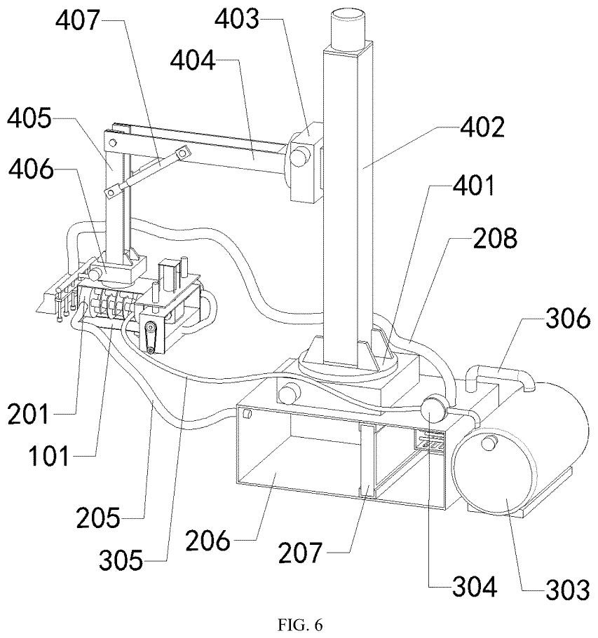

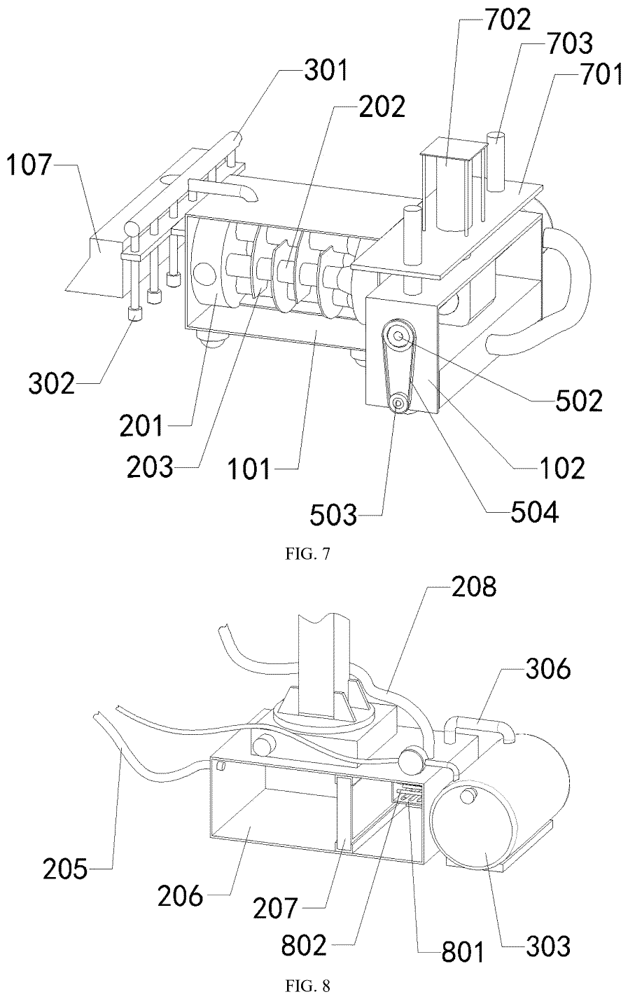

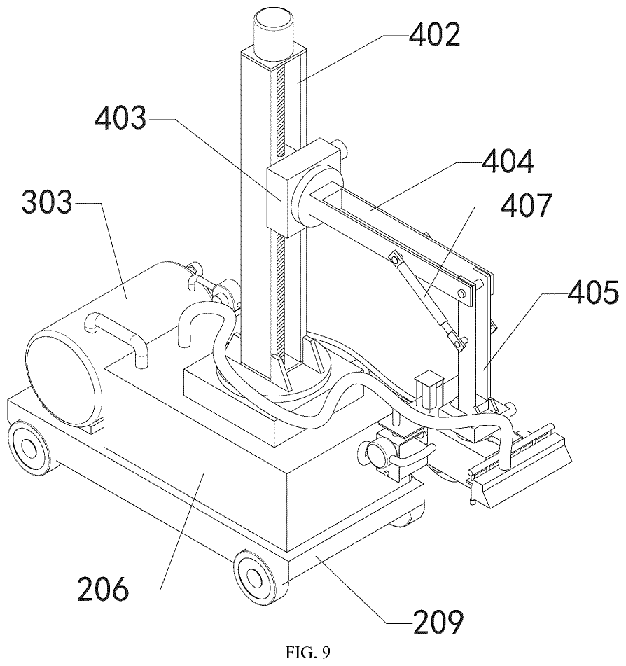

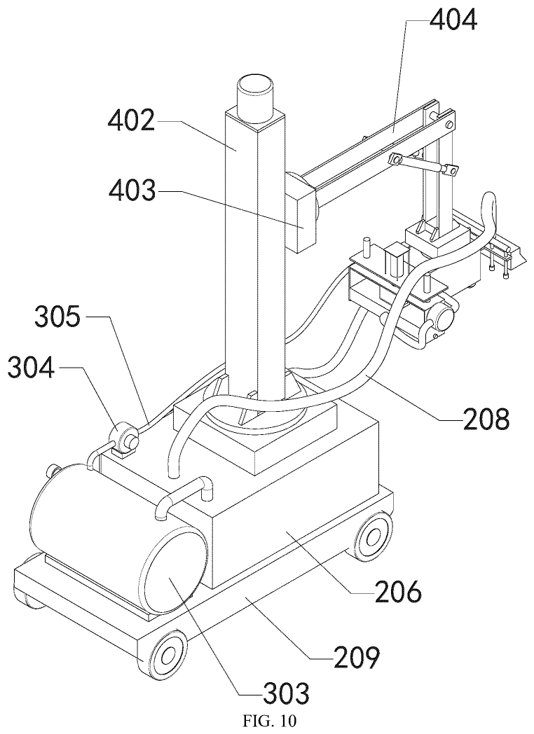

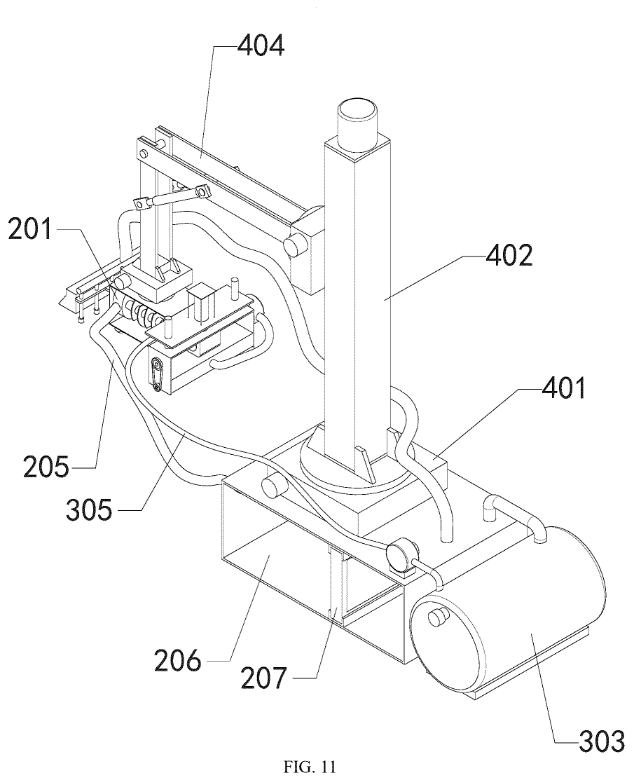

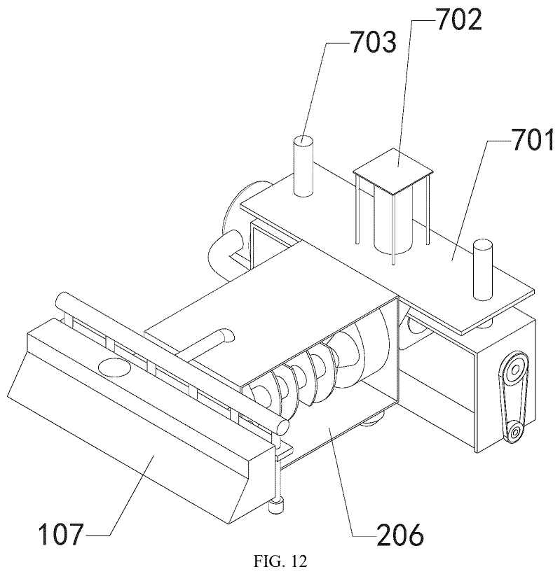

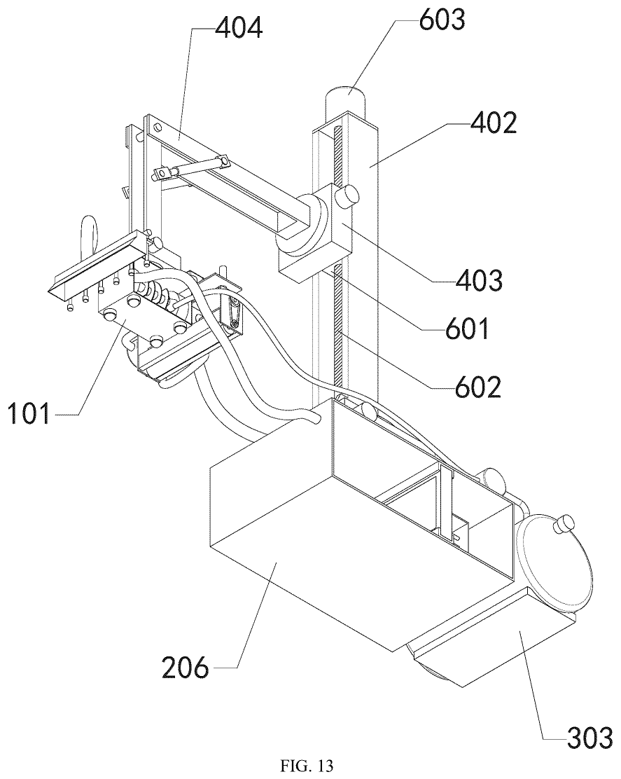

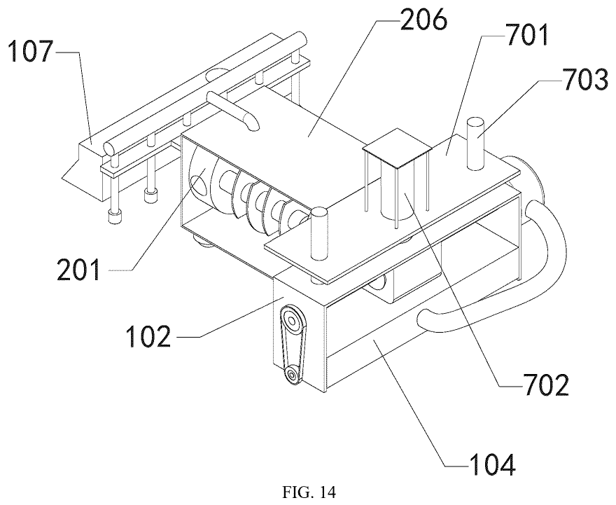

As shown from FIG. 1 to FIG. 14, the invention provides an anticorrosive construction machine for cofferdam of a ship, wherein the position of the machine case 101 is moved by the support device, so that the machine case 101 drives the grinding roller 103 to contact with the bulkhead where anticorrosion construction is needed. After that, the grinding roller 103 and fan 105 are powered by the driving device to make the grinding roller 103 rotate and then grind and descale the bulkhead, and at the same time, the fan 105 suctions the air in the collecting hood 104 to make the collecting hood 104 collect the ground debris, the air is heated up by the grinding roller 103 due to the friction of the grinding roller 103 in the grinding process; the collected debris and air are transported to the heat exchange device through the fan 105, and heat exchange device utilizes the heat of collecting debris and air to heat the anticorrosive material to increase the temperature, liquidity and drying speed thereof, then the heat exchange device will filter the collected debris, and the separated air will be heated again and transported to the exhaust hood 107, so that the exhaust hood 107 will dry the anticorrosive materials after spraying.

The invention has the following main functions: the heat exchange device utilizes the heat of collecting debris and air to heat the anticorrosive material to increase the temperature, liquidity and drying speed thereof, then the heat exchange device will filter the collected debris, and the separated air will be heated again and transported to the exhaust hood 107, so that the exhaust hood 107 will dry the anticorrosive materials after spraying. improve the waste air utilization, reduce the energy consumption of secondary heating of the air, improve the drying speed of the anticorrosive materials, and improve the efficiency of the construction.

For the anticorrosive construction machine for cofferdam of a ship provided by the invention, the fan 105, the car body 209, the pump 304, the first rotary table 401, the second rotary table 403, the third rotary table 406, the first electric cylinder 407, the first motor 501, the second motor 603, the second electric cylinder 702, and the electric heating tube 802 are purchased from the market, and those skilled in the art only need to follow the accompanying instruction manual, without the need for creative labor by the technical personnel in the art.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. An anticorrosive construction machine for cofferdam of a ship, comprising a support, a grinding roller, a support device, a lifting device, a driving device, a heat exchange device, a spraying device, a machine case, a collecting hood, a fan, a first conveying tube and an exhaust hood, wherein the grinding roller is rotatably arranged on an inner wall of the support, the machine case is arranged on the support device, the support is arranged on a side of the machine case in a vertically moving mode via the lifting device, the collecting hood is arranged on the inner wall of the support, the fan is arranged on an outer wall of the support, the driving device is arranged on the support and used for providing power for the grinding roller and the fan, an input end of the first conveying tube is connected with the collecting hood, and an output end of the first conveying tube is connected with the fan; an output end of the fan is connected to the heat exchange device, which is used to heat the anticorrosive material, the exhaust hood is installed on an outer wall of the machine case and is connected to the heat exchange device; the spraying device is installed on the machine case, which is used to spray the anticorrosive material.

2. The anticorrosive construction machine for cofferdam of a ship of claim 1, wherein the heat exchange device includes a heating device, two conveying cylinders, a plurality of heat exchange tubes, a plurality of guide plates, a housing, a second conveying tube, a filter box, a filter screen, a third conveying tube and a car body; two conveying cylinders are respectively installed on left and right parts of the machine case, left and right ends of a plurality of heat exchange tubes are respectively connected to two conveying cylinders, a plurality of guide plates are installed on outer wall of a plurality of heat exchange tubes in a staggered manner, two ends of the housing are connected to two conveying cylinders, and the housing is installed out of the heat exchange tubes, and the spraying device is connected to an interior of the housing, right conveying cylinder is connected to an output end of the fan, left conveying cylinder is connected to the second conveying tube, and an output end of the second conveying tube is connected to the filter box, which is installed at a top of the car body, and the support device is installed at a top of the filter box, the filter screen is installed in an inner wall of the filter box and there is a heating device in the filter box for heating the air for the second time; an input end of the third conveying tube is connected with the heating device, and an output end of the third conveying tube is connected with the exhaust hood.

3. The anticorrosive construction machine for cofferdam of a ship of claim 1, wherein the spraying device comprises a fourth conveying tube, a plurality of spray nozzles, a storage tank, a pump, a fifth conveying tube and a sixth conveying tube; the fourth conveying tube is mounted on the outer wall of the machine case, the fourth conveying tube is connected with the interior of the housing, a plurality of spray nozzles are connected to an outer wall of the fourth conveying tube, and the storage tank is mounted on the top of the car body; the pump is mounted on an outer wall of the filter box, an input end of the pump is connected to the storage tank, an output end of the pump is connected to the fifth conveying tube, an output end of the fifth conveying tube is connected to the housing, an input end of the sixth conveying tube is connected to interior of the filter box, and an output end of the sixth conveying tube is connected to the storage tank.

4. The anticorrosive construction machine for cofferdam of a ship of claim 1, wherein the support device comprises a power device, a first rotary table, a guide arm, a second rotary table, a cross arm, a connecting arm, a third rotary table and a plurality of first electric cylinders; the first rotary table is mounted on the top of the filter box, the guide arm is mounted on a rotary end of the first rotary table, the guide arm is equipped with a power device, which is used to drive the second rotary table to go up and down, the cross arm is mounted on a rotary end of the second rotary table, a top of the connecting arm is connected to an end of the cross arm, the third rotary table is mounted on a bottom end of the connecting arm, and a rotary end of the third rotary table is connected to top end of the machine case; a plurality of the first electric cylinders are all rotatably mounted on an outer wall of the cross arm, and mobile ends of a plurality of the first electric cylinders are all rotatably connected to an outer wall of the connecting arm.

5. The anticorrosive construction machine for cofferdam of a ship of claim 1, wherein the driving device comprises a first motor, a first pulley, a second pulley and a belt;
the first motor is mounted on the inner wall of the support, an output end of the first motor is connected to the fan, and another output end of the first motor is connected to the first pulley; the second pulley is mounted on an end of the grinding roller, and the belt is sleeved on an outer wall of the first pulley and the second pulley.

6. The anticorrosive construction machine for cofferdam of a ship of claim 4, wherein the power device includes a sliding block, a leading screw and a second motor; the sliding block is mounted in an inner wall of the guide arm in sliding up and down mode, the second rotary table is mounted on an outer wall of the sliding block, the leading screw is rotatably mounted on the inner wall of the guide arm, the sliding block is threadedly mounted on the leading screw, the second motor is mounted on a top end of the guide arm, and an output end of the second motor is connected with the leading screw.

7. The anticorrosive construction machine for cofferdam of a ship of claim 1, wherein the lifting device includes a support table, a second electric cylinder and a plurality of guide columns; the support table is mounted on an outer wall of the machine case, the second electric cylinder is mounted on an outer wall of the support table, mobile end of the second electric cylinder is connected to a top end of the support, and a plurality of guide columns are all slidably mounted on the support table, and bottom ends of a plurality of guide columns are all connected to the top end of the support.

8. The anticorrosive construction machine for cofferdam of a ship of claim 2, wherein the heating device includes a mesh box and electric heating tubes, the mesh box is connected to interior of the filter box, a top end of the mesh box is connected to an input end of the third conveying tube, and the electric heating tube is installed in an interior of the mesh box.

9. The anticorrosive construction machine for cofferdam of a ship of claim 1, wherein it also includes a plurality of bases and a plurality of ball transfers; a plurality of bases is installed on a bottom of the machine case, and a plurality of ball transfers are rotatably mounted on a plurality of bases.

10. The anticorrosive construction machine for cofferdam of a ship of claim 2, wherein there is also a closed door, and the closed door is connected to the outer wall of the filter box.
